(19) United States
(12) Patent Application Publication
(10) Pub. No.: US 2025/0159422 A1
(43) Pub. Date: May 15, 2025

(54) LOUDSPEAKER OPTIMIZATION AND ARRAY BUILDING ROUTINES

(71) Applicant: EAW NORTH AMERICA, INC., WHITINSVILLE, MA (US)

(72) Inventors: GEOFFREY PETER MCKINNON, PROVIDENCE, RI (US); WILLIAM HOY, BERKLEY, MA (US); MICHAEL WILLIAM MORRISON, VICTORIA (CA)

(21) Appl. No.: 18/507,756

(22) Filed: Nov. 13, 2023

(51) Int. Cl. H04R 29/00

(52) U.S. Cl. CPC H04R 29/001; H04R 29/008

(57) ABSTRACT

A loudspeaker includes a housing; one or more transducers within the housing; and a control system for controlling the one or more transducers. The control system includes a user interface supported by the housing, the user interface having one or more input elements for inputting one or more input parameters. The control system further includes a processor within the housing that is operatively coupled to the user interface and the one or more transducers. The processor is configured to perform an optimization routine in which the processor determines one or more control parameters for the one or more transducers based on the one or more input parameters.

### FIELD OF THE INVENTION

The present disclosure relates to optimization routines for a loudspeaker and more particularly, an optimization routine and array building routine for a loudspeaker.

### BACKGROUND OF THE INVENTION

Loudspeakers for live concerts and other large venues typically comprise one or more transducers that can be operated to generate sound for the venue. In particular, electrical energy can be applied to the transducer(s) according to various parameters (e.g., frequency, gain, etc.), and the transducer(s) will convert that energy into a mechanical pulse that generates sound. Moreover, the parameters at which the electrical energy is applied can be controlled to regulate one or more aspects of the sound, such as its direction and beamwidth.

For large concert venues, a large line array of loudspeakers is typically provided to cover the main audience area and the farthest areas of the venue. Meanwhile, smaller line arrays are provided to cover the outer sides and center of the audience area. Additional speakers may also be provided on stage to cover the closest audience members. In total, a sound system for a venue may have two to seven or more loudspeaker arrays arranged at various locations about the venue.

However, the loudspeaker configuration for a concert venue can vary depending on the size and arrangement of the venue. Moreover, sound equipment for live concerts is typically owned by a professional sound provider and travels with the band from venue to venue. Thus, at each venue, an appropriate sound system must be designed, assembled, and then fine-tuned for the venue.

When designing a sound system for a large concert venue, acoustic modeling software is initially used to roughly “draw” the venue prior to the show. That is, the definition of the venue is “drawn” in software using available information for the venue including its length, width, seating areas, stage elevation and position and size, balcony locations and positions, etc. From here, an initial loudspeaker configuration is determined to match the venue.

On the day of the show, a system engineer will arrive early at the venue to measure its dimensions and verify speaker rigging locations and trim height limitations. The venue configuration will then be updated in the modeling software, which will finalize an appropriate loudspeaker configuration for the venue. The loudspeakers are then flown (installed) in the venue according to their modeled configuration and connected to an electronic network with an external PC.

Once the loudspeakers are powered and connected to the network, software on the external PC will optimize the operating parameters for each transducer in the sound system, such that each transducer is fine-tuned to the venue. For example, the external PC will optimize the operating parameters for each transducer so that its sound is provided in an optimal direction and beamwidth for the venue.

An object of the present disclosure is to provide a loudspeaker that can self-optimize without having to connect the loudspeaker to a network with an external PC. Moreover, another object is for the loudspeaker to recognize its position within a speaker array and communicate with neighboring speakers, which can be useful for optimizing the speaker itself and/or other speakers within the array.

### BRIEF SUMMARY OF THE INVENTION

The following presents a simplified summary of example embodiments of the invention. This summary is not intended to identify critical elements or to delineate the scope of the invention.

In accordance with one aspect a loudspeaker includes a housing; one or more transducers within the housing; and a control system for controlling the one or more transducers. The control system includes a user interface supported by the housing, the user interface having one or more input elements for inputting one or more input parameters. The control system further includes a processor within the housing that is operatively coupled to the user interface and the one or more transducers. The processor is configured to perform an optimization routine in which the processor determines one or more control parameters for the one or more transducers based on the one or more input parameters.

In according with a second aspect, a loudspeaker includes a housing; one or more transducers within the housing; and a control system for controlling the one or more transducers. The control system includes a communication system supported by the housing and configured for communicating with a first adjacent speaker and a second adjacent speaker, and a processor within the housing that is operatively coupled to the one or more transducers. The processor is configured to perform an array building routine in which the processor determines an array configuration for the loudspeaker based on incoming data from the communication system.

### BRIEF DESCRIPTION OF THE DRAWINGS

The above and other features, aspects, and advantages of the present application are better understood when the following detailed description of the present application is read with reference to the accompanying drawings, in which:

FIG. 1 is a front view of an example loudspeaker;

FIG. 2 is a front view of the loudspeaker with a grill removed;

FIG. 3 is a rear view of the loudspeaker;

FIG. 4 is a schematic view of an interior of the loudspeaker;

FIG. 5 is an example optimization routine for the loudspeaker;

FIG. 6 is an example loudspeaker array comprising a plurality of loudspeakers, wherein each loudspeaker of the array corresponds to the loudspeaker in FIG. 1;

FIG. 7 is an example array building method for the array;

FIG. 8 is an example array building routine for the loudspeaker; and

FIG. 9 is another example array building routine for the loudspeaker.

### DETAILED DESCRIPTION

The following is a detailed description of illustrative embodiments of the present application. As these embodiments of the present application are described with reference to the aforementioned drawings, various modifications or adaptations of the methods and or specific structures described may become apparent to those skilled in the art. All such modifications, adaptations, or variations that rely upon the teachings of the present application, and through which these teachings have advanced the art, are considered to be within the spirit and scope of the present application. Hence, these descriptions and drawings are not to be considered in a limiting sense as it is understood that the present application is in no way limited to the embodiments illustrated. Moreover, certain terminology is used herein for convenience only and is not to be taken as a limitation. Still further, in the drawings, the same reference numerals are employed for designating the same elements.

Moreover, certain terminology is used herein for convenience only and is not to be taken as a limitation. For example, relative directional terms herein such as “top”, “bottom”, “upper”, “lower”, “above”, “below”, “left”, “right”, “front”, “rear”, and the like are used for convenience when describing the embodiments as oriented in the drawings. However, such orientation(s) are arbitrary, and different orientations can result rearranging which feature might be considered the “upper” or “lower,” etc. These references and other similar references in the present application are only to assist in helping describe and understand the present disclosure and invention and are not necessarily intended to limit the present disclosure or invention to these directions.

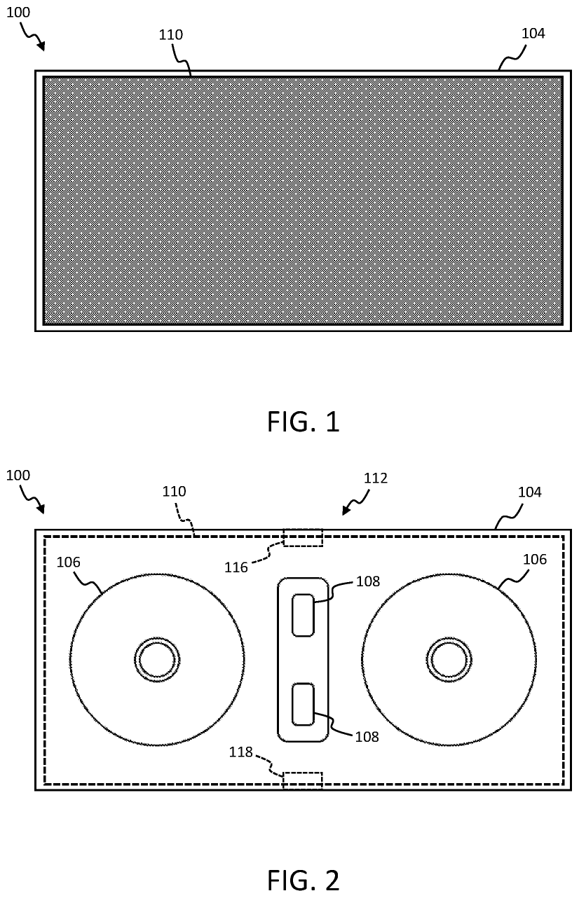

Turning to FIGS. 1 and 2, an example loudspeaker 100 is illustrated that includes a housing 104 and a plurality of transducers 106, 108 within the housing 104. Notably, the transducers 106, 108 are mounted within the housing 104 such that they are exposed through associated openings in a front side of the housing 104. Moreover, the loudspeaker 100 includes a perforated grill 110 that covers the transducers 106, 108 to protect them from foreign objects.

The loudspeaker 100 in the present example has two mid-frequency transducers 106 (operable in a range of about 200 Hz to 2 kHz) and two high-frequency transducers 108 (operable in a range of about 1500 Hz to 20 kHz). However, the loudspeaker 100 may one or more low-frequency transducers (operable in a range of about 30 Hz to 300 Hz) or ultra-low frequency transducers (operable in a range of about 20 to 200 Hz) in some examples. Broadly speaking, the loudspeaker 100 can include any number of one or more transducers without departing from the scope of the disclosure.

The loudspeaker 100 further includes a communication system 112 comprising a pair of communication devices 116, 118 on opposite sides of the housing 104 that are configured to communicate with adjacent speakers. In particular, the loudspeaker 100 has an upper communication device 116 mounted at a top side of the housing 104 for communicating with speakers in close proximity above the loudspeaker 100, and a lower communication device 118 mounted at a bottom side of the housing 104 for communicating with speakers in close proximity below the loudspeaker 100. However, the communication devices 116, 118 may be mounted at other locations of the housing 104, and may communicate with adjacent speakers on other sides of the housing 104 such as its left and right sides.

Each communication device 116, 118 in the present example is an infrared proximity sensor having an infrared transmitter and infrared receiver to enable two-way communication between the loudspeaker 100 and an adjacent speaker. However, other types of proximity sensors can be used such as ultrasonic or radar-based sensors. Moreover, the communication devices 116, 118 may comprise other components that can function to communicate wirelessly with an adjacent speaker via Wifi, Bluetooth, NFC, or other similar techniques. In some examples, the communication devices 116, 118 may comprise communication ports or terminals for establishing a wired connection with an adject speaker. Broadly speaking, the communication devices 116, 118 can be any device that enables the loudspeaker 100 to communicate (one or both ways) with an adjacent speaker via the device.

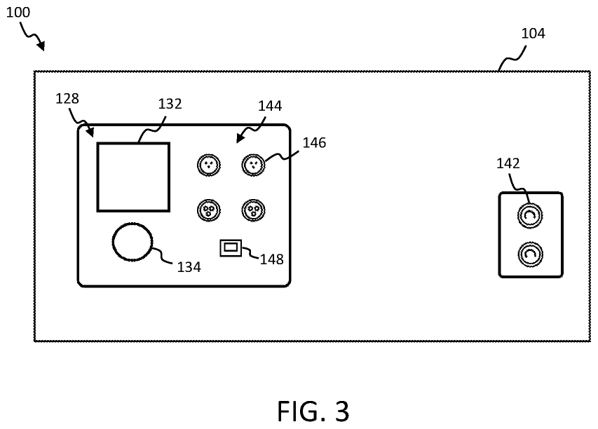

As shown in FIG. 3, the loudspeaker 100 further includes a user interface 128 mounted at a rear side of the housing 104, which includes an LCD display 132 and an input element 134 in the form of a control knob for navigating and entering information of the LCD display 132. For example, as discussed further below, a user can operate (e.g., rotate or push) the control knob 134 to input (e.g., select or enter) various parameters for an optimization routine of the speaker 100. Moreover, the LCD display 132 can provide visual feedback for the selected or entered parameters. However, the user interface 128 can comprise any configuration of one or more input elements (e.g., a touchscreen, buttons, switches, etc.) for inputting parameters for the speaker 100. In some examples, the user interface 128 may comprise an input element in the form of a communication device (e.g., port, terminal, antenna, etc.) that can connect to a personal device (e.g., computer, cell phone, etc.) of the user, so that the user can input parameters for the speaker 100 via the personal device.

Furthermore, the loudspeaker 100 can include a power connector 142 (e.g., Power Con AC Mains connector) for connecting the loudspeaker 100 to a power source, an audio input station 144 with one or more audio connectors 146 (e.g., XLR Input connectors) for connecting the loudspeaker 100 to an audio source, and one or more network connectors 148 (e.g., RJ-45 connectors) for connecting the loudspeaker 100 to a network.

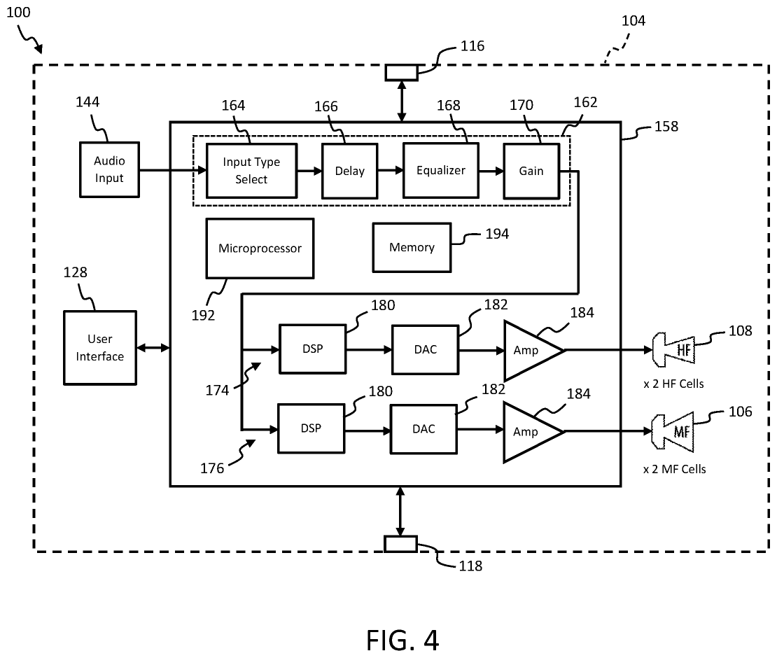

Turning to FIG. 4, the loudspeaker 100 includes a processing unit 158 within it housing 104 that is operatively coupled to the transducers 106, 108, communication devices 116, 118, user interface 128, and audio input station 144. Notably, the processing unit 158, communication devices 116, 118, and user interface 128 collectively form a control system 160 for the loudspeaker 100.

The processing unit 158 can include various components for processing an audio signal from the audio input station 144 and delivering the processed signal as an output to one or more of the transducers 106, 108. For instance, the processing unit 158 in the present example includes a main control station 162 with an input selector 164 for selecting a specific input from the audio input station 144, a delay subsystem 166 for controlling a delay of the input, a parametric equalizer 168 for controlling the frequency response, transfer function, etc. of the input, and a gain subsystem 170 for controlling a gain of the input. The output of the main control station 162 is then delivered to individualized control channels 174, 176 for each transducer 106, 108, wherein each channel 174, 176 includes a DSP module 180 for controlling the time and frequency response of the output, a digital-to-analog converter 182, and a power amplifier 184.

Finally, the processing unit 158 includes a microprocessor 192 and programmable memory 194, wherein the microprocessor 192 is configured to control the processing components described above according to software stored in the memory 194 and based on one or more inputs from the communication devices 116, 118 and user interface 128. Moreover, the microprocessor 192 can further control outputs of the communication devices 116, 118 and user interface 128.

It is to be appreciated that the processing unit 158 can include additional, fewer, or alternative processing components than those described above. Moreover, the processing unit 158 may be operatively coupled to other components such as the network connector(s) 148. Broadly speaking, the processing unit 158 can comprise any configuration of a processor and memory for controlling the outputs to one or more transducers.

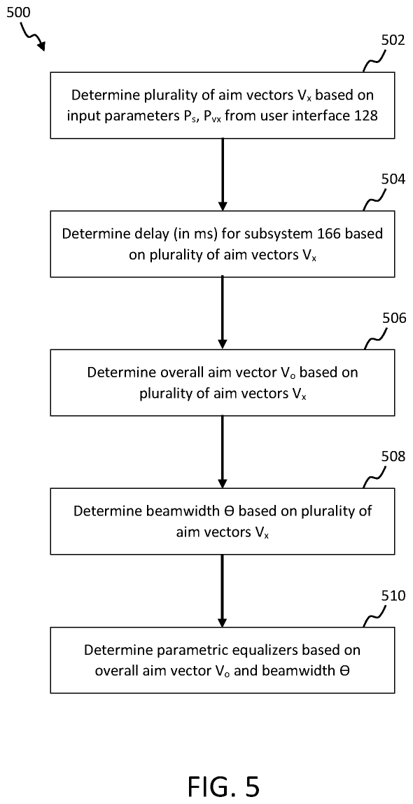

Turning to FIG. 5, an example optimization routine 500 will now be described that can be stored as software in the memory 194 of the processing unit 158 and executed by the microprocessor 192 for optimizing the sound generated by the transducers 106, 108 for a particular venue. The optimization routine 500 can be executed, for example, in response to a start command inputted by a user using the user interface 128, or automatically upon connecting the loudspeaker 100 to a power source.

As discussed further below, the optimization routine 500 can determine one or more control parameters (e.g., gain, delay, frequency, etc.) for the processing unit 158 based on one or more input parameters that are input using the user interface 128 (either before or during the routine 500) and stored in the memory 194 of the speaker 100. Such input parameters can include, for example, a spatial parameter of the speaker P_{S} corresponding to the speaker's location in the venue. In particular, the speaker spatial parameter P_{S} can be a distance or distances of the speaker 100 from one or more reference points in the venue, GPS coordinates for the speaker 100, or some other positional relationship of the speaker 100. In the present example, the speaker spatial parameter P_{LS} is a height of the speaker 100 from a floor of the venue.

The input parameters can further include a plurality of spatial parameters for the venue P_{VX}. In particular, the venue spatial parameters P_{V} can be distances of various locations in the venue from one or more reference points (e.g., the speaker 100), GPS coordinates of the venue locations, dimensions of the venue (e.g., width and length), or some other spatial relationship of the venue. In the present example, spatial parameters for the venue P_{V} include a first parameter P_{V1} corresponding to a height and length of the front of the audience from the speaker 100, and a second parameter P_{V2} corresponding to a height and length of the back of the audience from the speaker 100. Moreover, the venue spatial parameters P_{V} may include additional parameters corresponding to other locations of the audience in some examples.

The input parameters can include other parameters such as, for example, a number of total speakers and spatial parameters for the other speakers. Moreover, the input parameters can be input to the user interface 128 using the control knob 134 or some other input element (e.g., laser range finder) that is operatively coupled or otherwise in communication with the user interface 128. In turn, the user interface 128 will provide an electrical output to the microprocessor 192 that corresponds to the input parameters. Moreover, the microprocessor 192 will store the input parameters in the memory 194 and utilize those parameters for various steps in the optimization routine 500. The microprocessor 192 may also utilize those parameters for other routines such as, for example, an array building routine discussed further below.

As shown in FIG. 5, the optimization routine 500 can include a step 502 in which the microprocessor 192 determines a plurality of aim vectors Vₓ based on the input parameters from the user interface 128. For instance, in the present example, each vector Vₓ will be defined by the speaker spatial parameter P_{S} and an associated venue spatial parameter P_{V}. That is, a first vector V₁ will be defined as the vector from the speaker spatial parameter P_{S} to the first venue spatial parameter P_{V1} at the front of the audience, and a second vector V₂ will be defined as the vector from the speaker spatial parameter P_{S} to the second venue spatial parameter P_{V2} at the back of the audience.

The routine 500 can further include a step 504 in which the microprocessor 192 determines a delay (in ms) for each DSP module 180 of the processing unit 190 based on the aim vectors Vₓ determined in step 502. In particular, the microprocessor 192 can determine a length of each vector Vₓ and its angle (e.g., relative to horizontal), and then use the lengths and angles of the vectors Vₓ to calculate an appropriate delay. For instance, the delay for two sound sources (i.e., transducers 106, 108) can be adjusted such that both sound sources align along one or more of the aim vectors Vₓ.

The routine 500 can also include a step 506 in which the microprocessor 192 determines an overall aim vector V_{O} based on the aim vectors Vₓ determined in step 502. For example, the overall aim vector V_{O} can be a weighted average of the aim vectors Vₓ based on a total number of speakers for an array formed by the speaker 100 (the number being 1 if the speaker 100 is alone and does not form an array with other speakers). The total number of speakers can be an input parameter provided to the microprocessor 192 via the user interface 128, or a parameter that is determined using an array building routine discussed further below.

In some examples, the routine 500 can include a step 508 in which the microprocessor 192 determines an optimal beamwidth θ of the loudspeaker 100 based on the aim vectors Vₓ determined in step 502. For instance, the optimal beamwidth θ can be a range of the aim vectors Vₓ (e.g., between the highest to lowest aim vectors Vₓ).

Lastly, the routine 500 can include a step 510 in which the microprocessor 192 determines one or more parametric equalizer parameters (e.g., PEQ type, gain, frequency, and Q) for the DSP modules 180 of the transducers 106, 108 based on the overall aim vector V_{O} determined in step 504 and the beamwidth θ determined in step 508. For instance, experimental data of optimal parametric equalizer parameters versus overall aim vectors can be collected for primary and secondary use cases. Curve fitting is then applied to that data to build an algebraic formula, which can be stored in the memory 194 of the speaker 100 and used to calculate optimal parametric equalizer parameters based on the overall aim vector V_{O} determined in step 504.

As discussed above, the optimization routine 500 can determine various control parameters (e.g., gain, delay, frequency, etc.) for the processing unit 158 based on one or more input parameters (e.g., spatial parameters for the loudspeaker 100 and venue) that a user provides using the user interface 128. It is to be appreciated that the steps of the routine 500 do not necessarily have to be performed in the order described above. For instance, the routine 500 may perform steps 506, 508, 510 before step 504 in some examples. Moreover, the routine 500 may include additional, fewer, or alternative steps than those described above.

The loudspeaker 100 described above is thus capable of self-optimizing its sound output without having to connect the speaker to a network with an external PC. Rather, the loudspeaker 100 has a processing unit 190 with a microprocessor 192 that can execute the optimization routine 500 on the speaker itself. Indeed, the entire control system 160 of the loudspeaker 100 is “self-contained”, meaning that its components (e.g., the communication devices 116, 118, user interface 128, and processing unit 158) are all supported by (e.g., mounted within or on) the housing 104. In this manner, the loudspeaker 100 is a modular unit that can be connected to a power source and then independently optimized for a particular venue.

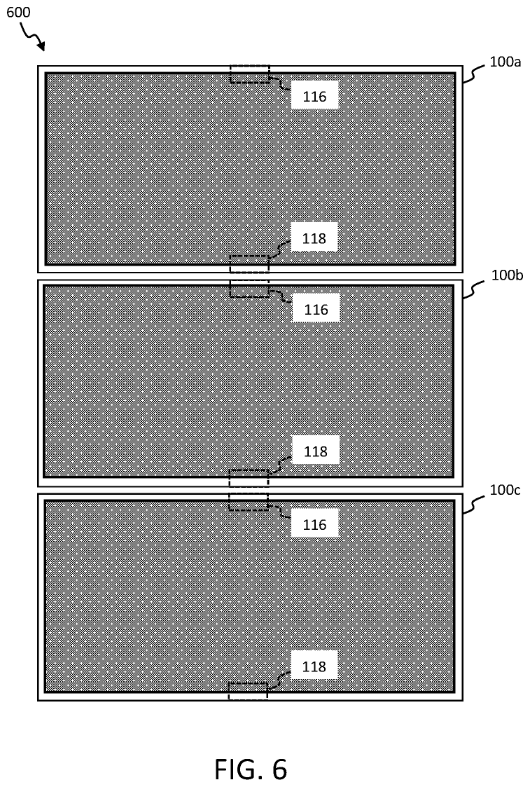

In some examples, the loudspeaker 100 may be arranged in an array with other similar or identical speakers that similarly include one or more transducers and a self-contained control system with a processing unit and one or more communication devices. For instance, FIG. 6 shows an example loudspeaker array 600 having a plurality of loudspeakers 100a-c, wherein each loudspeaker corresponds to the loudspeaker 100 described above. In particular, the loudspeakers 100a-c are linearly aligned in a vertical direction such that a top speaker 100a is arranged at an upper end of the array 600, a bottom speaker 100c is arranged at a lower end of the array 600, and an intermediate speaker 100b is arranged vertically between the top and bottom speakers 100a, 100c. However, the array 600 may include additional or fewer speakers in other examples. Moreover, the speakers of the array 600 may be linearly or non-linearly aligned in other directions (e.g., horizontal and/or curved) without departing from the scope of the disclosure.

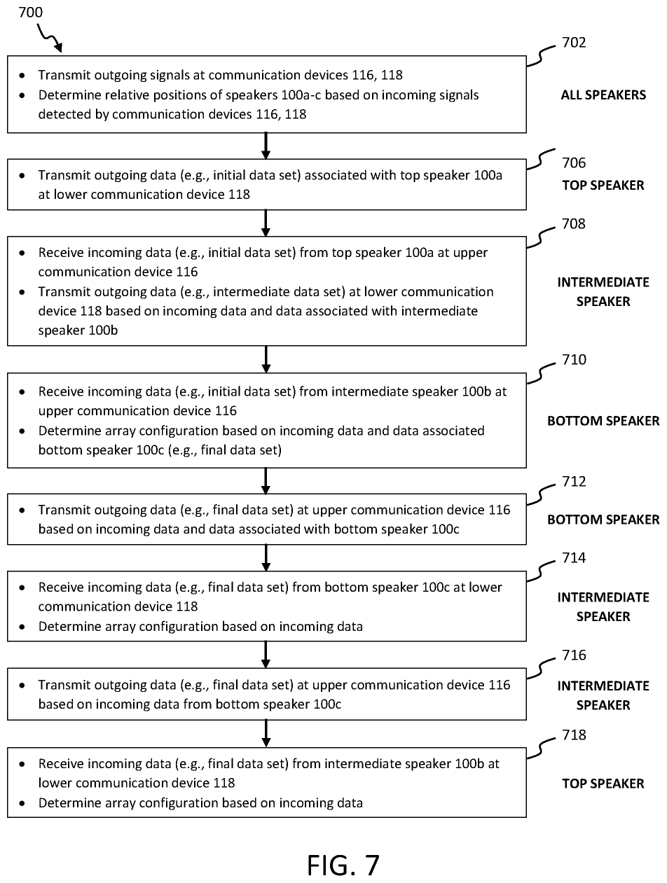

In embodiments wherein the loudspeaker 100 is part of a speaker array, it may be helpful for the loudspeaker 100 to recognize the array and communicate with other speakers therein for the purposes of optimizing each speaker. Thus, an example array building method 700 (see FIG. 7) will now be described for the array 600 shown in FIG. 6, wherein the method 700 enables each speaker 100a-c within the array 600 to recognize (“build”) the array 600 for the purposes of optimization.

Specifically, as shown in FIG. 7, the method 700 includes a first step 702 in which each speaker 100a-c operates its associated communication devices 116, 118 to determine if the speaker 100a-c is part of an array and if so, the speaker's relative position within the array 600 (e.g., the upper end, lower end, or somewhere in between).

Specifically, the microprocessor 192 of each speaker 100a-c will operates its associated communication devices 116, 118 to provide an outgoing signal indicating that the speaker 100a-c is present and in operation. In some examples, the outgoing signal for each speaker 100a-c may further include data associated with the speaker 100a-c such as, for example, identification data for the speaker 100a-c and input parameters (e.g., spatial parameters P_{S}, P_{V}) that are input to the speaker's user interface 128 for the optimization routine 500 discussed above.

Moreover, the microprocessor 192 of each speaker 100a-c will also monitor its associated communication devices 116, 118 for incoming signals indicating that a speaker is adjacent thereto. Depending on the speaker's position within the array 600, its communication devices 116, 118 will or will not receive a corresponding input signal, thereby indicating the speaker's relative position within the array 600.

For example, during the first step 702, the lower communication device 118 of the top speaker 100a will receive an incoming signal from the upper communication device 116 of the intermediate speaker 100b, thereby indicating that a speaker is below. However, the upper communication device 116 of the top speaker 100a will not receive any incoming signal, thereby indicating that no speaker is above. In this manner, the microprocessor 192 of the speaker 100a can confirm that the speaker 100a belongs to an array and is positioned at an upper end of the array.

Meanwhile, the upper communication 116 of the bottom speaker 100c will receive an incoming signal from the lower communication device 118 of the intermediate speaker 100b, thereby indicating that a speaker is above. However, the lower communication device 118 of the bottom speaker 100c will not receive any incoming signal, thereby indicating that no speaker is below. In this manner, the microprocessor 192 of the speaker 100c can confirm that the speaker 100c belongs to an array and is positioned at a lower end of the array.

Finally, the upper communication 116 of the intermediate speaker 100b will receive an incoming signal from the lower communication device 118 of the top speaker 100a, thereby indicating that a speaker is above. Moreover, the lower communication 118 of the intermediate speaker 100b will receive an incoming signal from the upper communication device 116 of the bottom speaker 100c, thereby indicating that a speaker is below. In this manner, the microprocessor 192 of the speaker 100b can confirm that the speaker 100b belongs to an array and is positioned between upper and lower ends of the array.

Thus, during step 702, the microprocessor 192 of each speaker 100a-c will determine that the speaker 100a-c belongs to an array and is positioned at some location along the array (e.g., the upper end, lower end, or somewhere in between). Moreover, the microprocessors 192 of the speakers 100a-c can perform additional steps described below to determine the exact configuration of the array.

Specifically, the method 700 can include a step 706 in which the microprocessor 192 of the top speaker 100a (as determined during step 702) operates its lower communication device 118 to transmit outgoing data associated with the top speaker 100a to the intermediate speaker 100b. Such outgoing data can be an “initial data set” that includes various data stored on the memory 194 of the speaker 100a including, for example, identification data for the speaker 100a, input parameters (e.g., spatial parameters P_{S}, P_{V}) that are input to the speaker's user interface 128 for the optimization routine 500 discussed above, and/or control parameters that are determined by the optimization routine 500.

The method 700 can include a next step 708 in which the microprocessor 192 of the intermediate speaker 100b (as determined during step 702) receives incoming data from the top speaker 100a (via the intermediate speaker's upper communication device 116), and then operates its lower communication device 118 to transmit outgoing data based on the incoming data and additional data associated with the intermediate speaker 100b. For example, the upper communication device 116 of the intermediate speaker 100b can receive the initial data set from the top speaker 100a, which includes data associated with the top speaker 100a. Moreover, the memory 194 of the intermediate speaker 100b can store additional data associated with the intermediate speaker 100b such as, for example, identification data for the speaker 100b, input parameters (e.g., spatial parameters P_{S}, P_{V}) that are input to the speaker's user interface 128 for the optimization routine 500 discussed above, and/or control parameters that are determined by the optimization routine 500. The microprocessor 192 of the intermediate speaker 100b can combine all of this data into an “intermediate data set”, and then operate the lower communication device 118 of the speaker 100b to transmit the intermediate data set to the bottom speaker 100c.

The method 700 can include a next step 710 in which the microprocessor 192 of the bottom speaker 100c (as determined during step 702) receives incoming data from the intermediate speaker 100b (via the bottom speaker's upper communication device 116), and then determines an array configuration based on the incoming data and additional data associated with the bottom speaker 100c. For example, the upper communication device 116 of the bottom speaker 100c can receive the intermediate data set from the intermediate speaker 100b, which includes data associated with the top and intermediate speakers 110a, 100b. Moreover, the memory 194 of the bottom speaker 100c can store other data associated with the bottom speaker 100c such as, for example, identification data for the speaker 100c, input parameters (e.g., spatial parameters P_{S}, P_{V}) that are input to the speaker's user interface 128 for the optimization routine 500 discussed above, and/or control parameters that are determined by the optimization routine 500. The microprocessor 192 of the bottom speaker 100c can combine all this data into a “final data set” that includes data associated with all three speakers 100a-c. Moreover, since the “final data set” now includes data from all three speakers 100a-c, the microprocessor 192 of the bottom speaker 100c can now accurately determine an overall array configuration for the array 600 based on the final data set (including the number of total speakers and location of each speaker within the array 600). In this manner, the microprocessor 192 of the bottom speaker 100c can recognize the configuration of the array 600 as well as the speaker's position within the array 600.

The method 700 can include a next step 712 in which the microprocessor 192 of the bottom speaker 100c operates its upper communication device 116 to transmit outgoing data to the intermediate speaker 100b. For instance, in one example, the microprocessor 192 can operate the upper communication device 116 to transmit the final data set that it uses in step 710 to determine an overall array configuration for the array 600. In another example, the microprocessor 192 can operate the upper communication device 116 to simply transmit the array configuration that it determines in step 710. In either case, the outgoing data will be based on the data that is used to determine the final data set (i.e., the incoming data from the intermediate speaker 100b and the data associated with the bottom speaker 100c).

The method 700 can include a next step 714 in which the microprocessor 192 of the intermediate speaker 100b receives incoming data from the bottom speaker 100c (via the intermediate speaker's lower communication device 118), and then determines an overall array configuration based on the incoming data. For example, the lower communication device 118 of the intermediate speaker 100b can receive the final data set from the bottom speaker 100c, and the microprocessor 192 can then calculate an overall array configuration for the array 600 based on the final data set. Alternatively, the lower communication device 118 of the intermediate speaker 100b may receive the overall array configuration from the bottom speaker 100c, and the microprocessor 192 can directly reference that incoming data for the overall array configuration. In this manner, the microprocessor 192 of the intermediate speaker 100b can recognize the configuration of the array 600 as well as the speaker's position within the array 600.

The method 700 can include a next step 716 in which the microprocessor 192 of the intermediate speaker 100b operates its upper communication device 116 to transmit outgoing data to the top speaker 100a based on the incoming data that it receives from the bottom speaker 100c in step 714. For instance, the microprocessor 192 of the intermediate speaker 100b can receive the final data set and/or overall array configuration from the bottom speaker 100c in step 714, which it can then transmit to the top speaker 100a in step 716 via the upper communication device 116.

Finally, the method 700 can include a next step 718 in which the microprocessor 192 of the top speaker 100a receives incoming data from the intermediate speaker 100b (via the top speaker's lower communication device 118), and then determines an overall array configuration based on the incoming data. For example, the lower communication device 118 of the top speaker 100a can receive the final data set from the intermediate speaker 100b, and the microprocessor 192 can then calculate an overall array configuration for the array 600 based on the final data set. Alternatively, the lower communication device 118 of the top speaker 100a may receive the overall array configuration from the intermediate speaker 100b, and the microprocessor 192 can directly reference that incoming data for the overall array configuration. In this manner, the microprocessor 192 of the top speaker 100a can recognize the configuration of the array 600 as well as the speaker's position within the array 600.

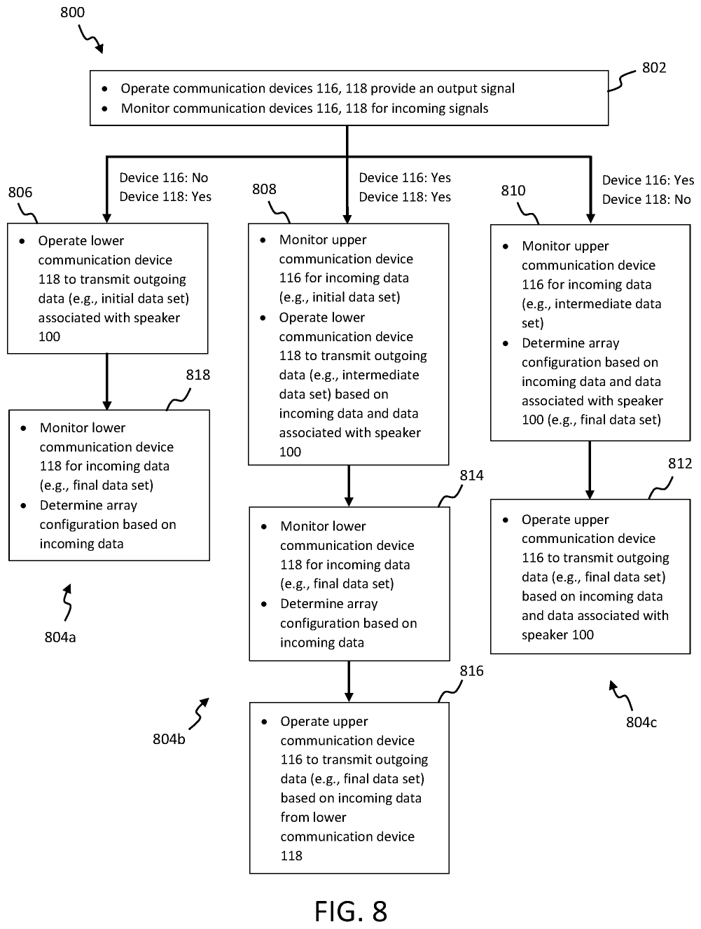

The method 700 described above can thus enable each speaker 100a-c in the array 600 to recognize the array 600 and the location of each speaker 100a-c within the array 600. Turning to FIG. 8, an example array building routine 800 will now be described, which can be stored as software in the memory 194 of each speaker 100a-c and executed by its associated microprocessor 192 to perform the method 700. The array building routine 800 can be executed by each speaker 100a-c in response to a start command inputted by a user on the speaker's user interface 128, or automatically upon connecting the loudspeaker 100a-c to a power source. Notably, the array building routine 800 can be performed before, during, or after the optimization routine 500 described above. In some examples, the array building routine 800 may be a subroutine of the optimization routine 500, or vice versa.

Initially, the routine 800 includes a first step 802 (corresponding to step 702 of the method 700) in which the microprocessor 192 operates both of its associated communication devices 116, 118 to provide an outgoing signal indicating that the speaker 100 is present and in operation. In some examples, the outgoing signal may further include data associated with the speaker 100 such as, for example, identification data for the speaker 100 and input parameters (e.g., spatial parameters P_{S}, P_{V}) that are input to the speaker's user interface 128 for the optimization routine 500 discussed above.

During step 802, the microprocessor 192 will also monitor both of the devices 116, 118 for detection of an incoming signal from an adjacent speaker. The microprocessor 192 will determine whether the devices 116, 118 detect an incoming signal, and then perform one of three different subroutines 804a, 804b, 804c depending on result of that determination.

For example, under a first condition in which the upper communication device 116 does not detect an incoming signal from an adjacent speaker and the lower communication device 118 detects an incoming signal from an adjacent speaker, this will indicate that the speaker 100 is at a first end (e.g., top end) of an array. Therefore, the microprocessor 192 can be configured to perform a first subroutine 804a in response to this condition, which corresponds to steps 706 and 718 of the method 700.

In particular, the first subroutine 804a includes a step 806 (corresponding to step 706 of the method 700) in which the microprocessor 192 operates the lower communication device 118 to transmit outgoing data associated with the speaker 100 (for receipt by an adjacent speaker). Such outgoing data can be an initial data set that includes various data stored on the memory 194 of the speaker 100 including, for example, identification data for the speaker 100, input parameters (e.g., spatial parameters P_{S}, P_{V}) that are input to the speaker's user interface 128 for the optimization routine 500 discussed above, and/or control parameters that are determined by the optimization routine 500.

The first subroutine 804a also includes a step 818 (corresponding to step 718 of the method 700) in which the microprocessor 192 monitors the lower communication device 118 for incoming data, and then determines an overall array configuration based on the incoming data. For example, the lower communication device 118 may receive a final data set from an adjacent speaker, and the microprocessor 192 can then calculate an overall array configuration based on the final data set. Alternatively, the lower communication device 118 may receive an overall array configuration from an adjacent speaker, and the microprocessor 192 can directly reference that incoming data for the overall array configuration.

Meanwhile, under a second condition in which both communication devices 116, 118 detect an incoming signal from an adjacent speaker, this will indicate that the speaker 100 is in between ends of an array. Therefore, the microprocessor 192 can be configured to perform a second subroutine 804b in response to this condition, which corresponds to steps 708, 714, and 716 of the method 700.

In particular, the second subroutine 804b includes a step 808 (corresponding to step 708 of the method 700) in which the microprocessor 192 monitors the upper communication device 116 for incoming data and then operates the lower communication device 118 to transmit outgoing data based on the incoming data and additional data associated with the speaker 100 and stored in its memory 194. For example, the upper communication device 116 may receive a data set (e.g., initial data set) from an adjacent speaker, which can include data associated with that adjacent speaker as well as other speakers located above the adjacent speaker in the array. Moreover, the memory 194 of the speaker 100 can store additional data associated with the speaker 100 itself such as, for example, identification data for the speaker 100, input parameters (e.g., spatial parameters P_{S}, P_{V}) that are input to the speaker's user interface 128 for the optimization routine 500 discussed above, and/or control parameters that are determined by the optimization routine 500. The microprocessor 192 of the speaker 100 can combine all this data into an intermediate data set, and then operate the lower communication device 118 of the speaker 100 to transmit the intermediate data set.

The second subroutine 804b also includes a step 814 (corresponding to step 714 of the method 700) in which the microprocessor 192 monitors the lower communication device 118 for incoming data and then determines an overall array configuration based on the incoming data. For example, the lower communication device 118 may receive a final data set from an adjacent speaker, and the microprocessor 192 can calculate an overall array configuration based on the final data set. Alternatively, the lower communication device 118 may receive an overall array configuration from an adjacent speaker, and the microprocessor 192 can directly reference that incoming data for the overall array configuration.

The second subroutine 804b also includes a step 816 (corresponding to step 716 of the method 700) in which the microprocessor 192 operates the upper communication device 116 to transmit outgoing data based on incoming data from the lower communication device 118. For example, the lower communication device 118 may receive a final data set and/or array configuration from an adjacent speaker, and the microprocessor 192 can operate the upper communication device 116 to transmit that data.

Meanwhile, under a third condition in which the upper communication device 116 detects an incoming signal from an adjacent speaker and the lower communication device 118 does not detect an incoming signal from an adjacent speaker, this will indicate that the speaker 100 is at another end (e.g., bottom end) of an array. Therefore, the microprocessor 192 can be configured to perform a third subroutine 804c in response to this condition, which corresponds to steps 710, 712 of the method 700.

In particular, the third subroutine 804c includes a step 810 (corresponding to step 710 of the method 700) in which the microprocessor 192 monitors the upper communication device 116 for incoming data and then determines an array configuration based on the incoming data. For example, the upper communication device 116 may receive an initial or intermediate data set from an adjacent speaker, which can include data associated with that adjacent speaker as well as other speakers located above the adjacent speaker in the array. Moreover, the memory 194 of the speaker 100 can store additional data associated with the speaker 100 itself such as, for example, identification data for the speaker 100, input parameters (e.g., spatial parameters P_{S}, P_{V}) that are input to the speaker's user interface 128 for the optimization routine 500 discussed above, and/or control parameters that are determined by the optimization routine 500. The microprocessor 192 of the speaker 100 can combine all this data into a final data set, and then determine an overall array configuration for the array (including the number of total speakers and location of each speaker within the array) based on the final data set.

The third subroutine 804c also includes a step 812 (corresponding to step 712 of the method 700) in which the microprocessor 192 operates the upper communication device 116 to transmit outgoing data. For example, the microprocessor 192 can operate the upper communication device 116 to transmit the final data set that is used to determine the overall array configuration in step 810. In addition or alternatively, the microprocessor 192 can operate the upper communication device 116 to transmit the overall array configuration. In either case, the outgoing data will be based on whatever data is used to determine the final data set (i.e., the incoming data from the upper communication device 116 and the data associated with the bottom speaker 100).

The routine 800 can end upon completion of any of the subroutines 804a, 804b, 804c discussed above. Moreover, in some examples, the routine 800 can restart upon completion, such that the speaker 100 continuously executes the routine 800 to determine and update the array configuration for the speaker 100.

The array building routine 800 described above can be programmed into the memory 194 of each speaker 100a-c of the array 600 in FIG. 6. Moreover, as can be appreciated by the above disclosure, the array building routine 800 once executed on all speakers 100a-c will perform the method 700 shown in FIG. 7. The array building method 700 and routine 800 can enable each speaker 100a-c to determine various information that can be useful for its optimization routine 500. For example, the array building method 700 and routine 800 can enable each speaker 100a-c to recognize the configuration of the array 600 as well as each speaker's position within the array 600.

Moreover, the array building method 700 and routine 800 can enable each speaker 100a-c to gather optimization data that is input on or determined by the other speakers 100a-c. That is, as discussed above, the array building method 700 and routine 800 can create a final data set that includes data from every speaker 100a-c in the array 600, including input parameters (e.g., spatial parameters P_{S}, P_{V}) that are input to each speaker's user interface 128 and/or control parameters that are determined by each speaker's optimization routine 500. Moreover, that final data set can be determined at one speaker (e.g., the bottom speaker 100c) and then communicated to the remaining speakers 100a. 100b in the array 600 at later steps in the array building method 700 and routine 800. Thus, any input parameters or control parameters stored on one speaker 100a-c will be communicated to the remaining speakers 100a-c and may be utilized for optimization routines in those remaining speakers 100a-c.

It is to be appreciated that the array building routine 800 can perform similar methods in other arrays having different numbers and/or alignments of speakers 100. For example, for a vertical array having a top speaker, bottom speaker, and multiple intermediate speakers, the array building routine 800 would perform a similar array building method wherein each intermediate speaker receives an incoming data set and transmits an updated data set including the incoming data set and additional data associated with the speaker itself. As another example, for a horizontal array having a left speaker, right speaker, and an intermediate speaker, the array building routine 800 can perform a similar array building method that begins at a first end (e.g., the left end) of the array, progresses to the second end (e.g., the right end) of the array, and then returns to the first end.

Moreover, the array building method 700 and routine 800 can have various modifications without departing from the scope of the disclosure. For example, for various steps of the method 700 and routine 800 described above, the microprocessor 192 actively monitors a communication device for incoming data during the associated step and then performs another action based on the incoming data. In other examples, the communication device may receive incoming data prior to the associated step, which can be stored in the speaker's memory 194 and later utilized by the microprocessor 192 during the associated step.

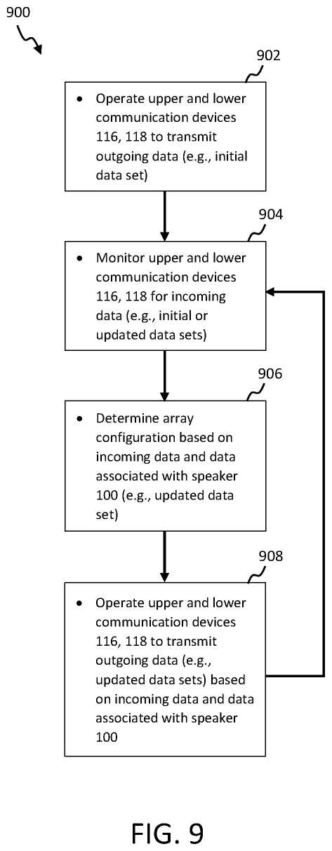

Turning to FIG. 9, one alternative array building routine 900 will now be described in further detail. The routine 900 can similarly be programmed into the memory 194 of each speaker 100a-c in the array 600 discussed above. Moreover, the routine 900 can be executed by each speaker 100a-c in response to a start command inputted by a user on the speaker's user interface 128, or automatically upon connecting the loudspeaker 100a-c to a power source. Notably, the array building routine 900 can be performed before, during, or after the optimization routine 500 described above. In some examples, the array building routine 900 may be a subroutine of the optimization routine 500, or vice versa.

The routine 900 includes an initial step 902 in which the microprocessor 192 of the speaker 100 operates both the upper and lower communication devices 116, 118 to transmit outgoing data. Such outing data can be an “initial data set” that includes, for example, identification data for the speaker 100, input parameters (e.g., spatial parameters P_{S}, P_{V}) that are input to the speaker's user interface 128 for the optimization routine 500 discussed above, and/or control parameters that are determined by the optimization routine 500. For example, as applied to the array 600 of FIG. 6, each speaker 100a-c would initially transmit a respective initial data set for the speaker 100a-c.

The routine 900 next includes a step 904 in which the microprocessor 192 of the speaker 100 monitors both the upper and lower communication devices 116, 118 for incoming data from adjacent speakers. For example, as applied to the array 600 of FIG. 6, the microprocessor 192 of the intermediate speaker 100b would receive initial data sets from the top and bottom speakers 100a. 100c via the upper and lower communication devices 116, 118, respectively. Meanwhile, the microprocessors 192 of the top and bottom speakers 100a. 100c would receive an initial data set from the intermediate speaker 100b.

The routine 900 next includes a step 906 in which the microprocessor 192 of the speaker 100 determines an array configuration based on the incoming data and data associated with the speaker 100 itself. For example, as applied to the array 600 of FIG. 6, the microprocessor 192 of the intermediate speaker 100b can receive initial data sets from the top and bottom speakers 100a, which can include data associated with those speakers. Moreover, the memory 194 of the speaker 100b can store additional data associated with the speaker 100b itself such as, for example, identification data for the speaker 100b, input parameters (e.g., spatial parameters P_{S}, P_{V}) that are input to the speaker's user interface 128 for the optimization routine 500 discussed above, and/or control parameters that are determined by the optimization routine 500. The microprocessor 192 of the speaker 100b can combine all this data into an “updated data set”, and then determine an overall array configuration for the array (including the number of total speakers and location of each speaker within the array) based on the updated data set. In this manner, the microprocessor 192 of the intermediate speaker 100b can recognize the configuration of the array 600 as well as each speaker's position within the array 600.

The top and bottom speakers 100a, 100c will similarly determine an array configuration based on incoming data at step 906. However, the top and bottom speakers 100a, 100c will initially not be aware of each other in the routine 900, since they have only received an initial data set from the intermediate speaker 100b. As such, the array configuration initially determined by those speakers 100a, 100c at step 906 will not be an accurate representation of the array 600. Nevertheless, as discussed below, the routine 900 will continuously repeat and update itself such that the speakers 100a, 100c ultimately determine an accurate configuration for the array 600.

More specifically, the routine 900 next includes a step 906 in which the microprocessor 192 of the speaker 100 operates both of its upper and lower communication devices 116, 118 to transmit outgoing data based on the incoming data it receives in step 904 and associated data for the speaker 100. For example, as applied to the array 600 of FIG. 6, the microprocessor 192 of the intermediate speaker 100b will operate both of its upper and lower communication devices 116, 118 to transmit the updated data set that it determines in step 906, which includes data associated with all three speakers 100a-c. The top and bottom speakers 100a, 100c will also transmit updated data sets, although such data sets will only include data for the respective speaker 100a, 100c and the intermediate speaker 100b.

Next, the routine 900 will return to step 904 and continuously repeat steps 904, 906, and 908. As applied to the array 600 of FIG. 6, the top and bottom speakers 100a, 100c will each receive an updated data set from the intermediate speaker 100b that now includes data associated with all three speakers 100a-c. From there, the top and bottom speakers 100a, 100c will again determine an array configuration based on the updated data set, which will now accurately represent the array 600. In this manner, the microprocessor 192 of the top and bottom speakers 100a, 100c will also recognize the configuration of the array 600 as well as each speaker's position within the array 600. Moreover, because the routine 900 continuously repeat steps 904, 906, and 908, each speaker 100a-c within the array 600 will continuously update the array configuration for speakers 100 that are added or removed from the array 600.

The speaker 100 as described above is thus a modular unit with adaptive software programmed into its on-board memory 194 that enables the speaker 100 to determine its position within a speaker array and generate optimized control parameters for the speaker 100 itself (and in some cases other speakers within the array). The speaker 100 may include other adaptive software and hardware such as the adaptive features described in U.S. Pat. Nos. 9,661,418, 9,911,406, and 10,129,644, which are hereby incorporated by reference in their entirety.

Notably, the communication system 112 of the speaker 100 described above has two communication devices 116, 118 that can communicate with respective speakers to perform the array building routines 800, 900. However, the communication system 112 may comprise any number of one or more communication devices without departing from the scope of the disclosure. For example, the communication system 112 may comprise a single communication device (e.g., proximity sensor, communication port, etc.) that can perform the operations for both of the first and second communication devices 116, 118 described above.

It is to be appreciated that the term “subroutine” as used herein when referring to a particular routine refers to one or more steps within the routine. The subroutine may be conditioned upon determinations made in previous steps of the routine (see e.g., the subroutines 804a, 804b, 804c described above). Alternatively, the subroutine may simply be one or more steps that are performed at some stage of the routine.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A loudspeaker comprising:
a housing;
one or more transducers within the housing; and
a control system for controlling the one or more transducers, the control system comprising:
a user interface supported by the housing, the user interface having one or more input elements for inputting one or more input parameters, and
a processor within the housing that is operatively coupled to the user interface and the one or more transducers, wherein the processor is configured to perform an optimization routine in which the processor determines one or more control parameters for the one or more transducers based on the one or more input parameters.

2. The loudspeaker according to claim 1, wherein the one or more input parameters includes a speaker spatial parameter and a plurality of venue spatial parameters.

3. The loudspeaker according to claim 2, wherein during the optimization routine, the processor determines a plurality of aim vectors based on the speaker spatial parameter and the plurality of venue spatial parameters.

4. The loudspeaker according to claim 3, wherein during the optimization routine, the processor determines a delay for the one or more transducers based on a length and an angle of each aim vector.

5. The loudspeaker according to claim 3, wherein during the optimization routine, the processor determines:
an overall aim vector and a beamwidth based on the plurality of aim vectors, and
one or more parametric equalizers based on the overall aim vector and beamwidth.

6. The loudspeaker according to claim 1, wherein:
the control system includes a communication system supported by the housing and configured for communicating with a first adjacent speaker and a second adjacent speaker, and
the processor is configured to perform an array building routine in which the processor determines an array configuration for the loudspeaker based on incoming data from the communication system.

7. The loudspeaker according to claim 6, wherein the communication system includes:
a first communication device configured for communicating with the first adjacent speaker, and
a second communication device configured for communicating with the second adjacent speaker.

8. The loudspeaker according to claim 7, wherein the array building routine includes a step in which the processor determines whether the first communication device and second communication device respectively detect a first incoming signal and a second incoming signal.

9. The loudspeaker according to claim 7, wherein the array building routine includes a subroutine in which the processor:
operates the second communication device to transmit outgoing data based on data associated with the speaker, and
determines the array configuration for the loudspeaker based on the incoming data from the second communication device.

10. The loudspeaker according to claim 9, wherein:
the array building routine includes a step in which the processor determines whether the first communication device and second communication device respectively detect a first incoming signal and a second incoming signal, and
the processor is configured to perform the subroutine in response to a condition in which the first communication device does not detect the first incoming signal and the second communication device detects the second incoming signal.

11. The loudspeaker according to claim 7, wherein the array building routine includes a subroutine in which the processor:
operates the second communication device to transmit outgoing data based on one or both of the incoming data from the first communication device and the incoming data from the second communication device,
operates the first communication device to transmit outgoing data based on one or both of the incoming data from the first communication device and the incoming data from the second communication device.

12. The loudspeaker according to claim 11, wherein:
the array building routine includes a step in which the processor determines whether the first communication device and second communication device respectively detect a first incoming signal and a second incoming signal, and
the processor is configured to perform the subroutine in response to a condition in which the first communication device detects the first incoming signal and the second communication device detects the second incoming signal.

13. The loudspeaker according to claim 11, wherein:
the outgoing data transmitted by the second communication device is a data set that includes the incoming data from the first communication device and data associated with the loudspeaker, and
the array configuration is determined based on the incoming data from the second communication device.

14. The loudspeaker according to claim 13, wherein the outgoing data transmitted by the first communication device includes the incoming data from the second communication device.

15. The loudspeaker according to claim 11, wherein:
the array configuration is determined based on a data set that includes the incoming data from the first communication device, the incoming data from the second communication device, and data associated with the loudspeaker, and
the outgoing data transmitted by the first communication device and the outgoing data transmitted by the second communication device each include the data set.

16. The loudspeaker according to claim 7, wherein the array building routine includes a subroutine in which the processor:
determines the array configuration for the loudspeaker based on the incoming data from the first communication device, and
transmits outgoing data to the first communication device based on the incoming data from the first communication device and data associated with the loudspeaker.

17. The loudspeaker according to claim 16, wherein:
the array building routine includes a step in which the processor determines whether the first communication device and second communication device respectively detect a first incoming signal and a second incoming signal, and
the processor is configured to perform the subroutine in response to a condition in which the first communication device detects the first incoming signal and the second communication device does not detect the second incoming signal.

18. The loudspeaker according to claim 16, wherein the outgoing data transmitted by the first communication device is a data set that includes the incoming data from the first communication device and the data associated with the loudspeaker.

19. The loudspeaker according to claim 16, wherein the outgoing data transmitted by the first communication device includes the array configuration.

20. A loudspeaker comprising:
a housing;
one or more transducers within the housing; and
a control system for controlling the one or more transducers, the control system comprising:
a communication system supported by the housing and configured for communicating with a first adjacent speaker and a second adjacent speaker,
a processor within the housing that is operatively coupled to the one or more transducers, wherein the processor is configured to perform an array building routine in which the processor determines an array configuration for the loudspeaker based on incoming data from the communication system.
